(19) United States
(12) Patent Application Publication
(10) Pub. No.: US 2021/0035464 A1
(43) Pub. Date: Feb. 4, 2021

(54) Science Education Project

(71) Applicants: Kristhian Otero, San Lorenzo, PR (US); Julio Cay, San Lorenzo, PR (US); Javier Otero, San Lorenzo, PR (US)

(72) Inventors: Kristhian Otero, San Lorenzo, PR (US); Julio Cay, San Lorenzo, PR (US); Javier Otero, San Lorenzo, PR (US)

(21) Appl. No.: 16/944,894

(22) Filed: Jul. 31, 2020

Related U.S. Application Data
(60) Provisional application No. 62/882,482, filed on Aug. 3, 2019.

(51) Int. Cl. G09B 5/14; H04L 29/08; G09B 23/18; G09B 23/16; G09B 5/04; G09B 23/24

(52) U.S. Cl. CPC G09B 5/14; H04L 67/12; G09B 23/24; G09B 23/16; G09B 5/04; G09B 23/181

(57) ABSTRACT

A system and method for both in person and/or remote science education, with a focus on systems and devices that enable hands-on experiments performance/measurement with remote student/teacher interaction exercises within a science educational environment. The system allows the real time streaming of educational material, data and the acquisition of the analytical data of the experiments in person and/or remote class sessions.

### CROSS-REFERENCE TO RELATED APPLICATIONS

This application claims priority to co-pending U.S. Provisional patent application Ser. No. 61/832,913 titled “Science Education Project”, filed on Aug. 3, 2020 the disclosure of which is herein incorporated by reference in its entirety.

### PATENTS CITED

The following documents and references are incorporated by reference in their entirety, Hakim (U.S. Pat. No. 6,760,748), Singer et al (U.S. Pat. Pub. No. 2010/0190245), Voorhees et al (U.S. Pat. No. 5,946,471), Rivkin (U.S. Pat. No. 9,268,619).

### FIELD OF THE INVENTION

The present invention relates generally to a system and method suitable for a science education project system and method and particularly to a number of devices that facility the hands-on teaching of science in an educational environment.

### DESCRIPTION OF THE RELATED ART

The teaching of science in the 21^{st} Century remains a one-on-one experience of Socratic nature. An experience that is one in which a student, or a group of students, go through the effort of replicating an experiment under close supervision of a teacher. This is of course very resource intensive.

The attempts at ‘clustering’ the supervision of students/groups, via electronics, have resulted in many systems that are of necessity high cost, since they use commercial laboratory quality electronics and sensors, cobbled together with electronics meant for other applications. In short, it very much resembles aviation efforts, where the same screen that everyone has in their cell phone costs 5X, because they simply don't have the economies of scales.

What is required, is a way to consumer-priced user experience and interface electronics with specific scientific technology in a fashion that is cost effective but that allows the force multiplication of an instructor overseeing multiple groups, preserving safety while reducing costs.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a system for interactive student education, said system comprising one or more teacher stations, one or more student stations, a system controller, one or more student interaction interface modules, each said interface module capable of interacting with one or more sensors, wherein said one or more controller(s), said teacher station(s), said student station(s) and said interaction interface modules are electronically networked. In another aspect said student interaction interface module is comprised of a science interface module unit comprised of both analog and digital electronic sampling and communication circuits capable of electrically interfacing to one or more, individually or simultaneously of the following: pH probe, voltage measurement, current measurement, temperature gage probe, pressure gage probe, electrical resistance measurement or electrical conductivity measurement while tracking the measurements over time and communicating them to said student station and/or said teacher station. In yet another aspect one or more of said student stations are located in a physical location that is remote to one or more of said teacher stations. In another aspect said student interaction interface module is comprised of a language interface module unit comprised of both analog and digital electronic sampling and communication circuits capable of electrically interfacing to one or more of the following: a headset, earpiece, microphone or similar audio communication component capable of capturing/generating sounds (in either analog or digital form) and transmitting/communicating the signals to said student station and/or said teacher station. In yet another aspect, one or more of said student stations are located in a physical location that is remote to one or more of said teacher stations. In another aspect said student interaction interface module is comprised of a writing interface module unit comprised of a digital desk pad sampling and communication circuits capable of electrically interfacing to one or more of the following: a digital desk pad capable of capturing/generating signals that replicate a student's graphical interaction with said pad and transmitting/communicating the signals to said student station and/or said teacher station. In yet another aspect, one or more of said student stations are located in a physical location that is remote to one or more of said teacher stations.

In one aspect the invention is about a computer-implemented method for interactive student education, performed by one or more processors, said method comprising: providing one or more teacher stations, providing one or more student stations, providing a system controller, providing one or more student interaction interface modules, each said interface module capable of interacting with one or more sensors, wherein said one or more controller(s), said teacher station(s), said student station(s) and said interaction interface modules are electronically networked. In another aspect said student interaction interface module is comprised of a science interface module unit comprised of both analog and digital electronic sampling and communication circuits capable of electrically interfacing to one or more, individually or simultaneously of the following: pH probe, voltage measurement, current measurement, temperature gage probe, pressure gage probe, electrical resistance measurement or electrical conductivity measurement while tracking the measurements over time and communicating them to said student station and/or said teacher station. In yet another aspect one or more of said student stations are located in a physical location that is remote to one or more of said teacher stations. In another aspect said student interaction interface module is comprised of a language interface module unit comprised of both analog and digital electronic sampling and communication circuits capable of electrically interfacing to one or more of the following: a headset, earpiece, microphone or similar audio communication component capable of capturing/generating sounds (in either analog or digital form) and transmitting/communicating the signals to said student station and/or said teacher station. In yet another aspect, one or more of said student stations are located in a physical location that is remote to one or more of said teacher stations. In another aspect said student interaction interface module is comprised of a writing interface module unit comprised of a digital desk pad sampling and communication circuits capable of electrically interfacing to one or more of the following: a digital desk pad capable of capturing/generating signals that replicate a student's graphical interaction with said pad and transmitting/communicating the signals to said student station and/or said teacher station. In yet another aspect, one or more of said student stations are located in a physical location that is remote to one or more of said teacher stations.

In one aspect, the invention is about a non-transitory computer-readable medium storing computer-readable instructions executable by a computer including one or more processors, and the computer-readable instructions configured, when executed by the one or more processors to: providing one or more teacher stations, providing one or more student stations, providing a system controller, providing one or more student interaction interface modules, each said interface module capable of interacting with one or more sensors, wherein said one or more controller(s), said teacher station(s), said student station(s) and said interaction interface modules are electronically networked. In another aspect said student interaction interface module is comprised of a science interface module unit comprised of both analog and digital electronic sampling and communication circuits capable of electrically interfacing to one or more, individually or simultaneously of the following: pH probe, voltage measurement, current measurement, temperature gage probe, pressure gage probe, electrical resistance measurement or electrical conductivity measurement while tracking the measurements over time and communicating them to said student station and/or said teacher station. In yet another aspect one or more of said student stations are located in a physical location that is remote to one or more of said teacher stations. In another aspect said student interaction interface module is comprised of a language interface module unit comprised of both analog and digital electronic sampling and communication circuits capable of electrically interfacing to one or more of the following: a headset, earpiece, microphone or similar audio communication component capable of capturing/generating sounds (in either analog or digital form) and transmitting/communicating the signals to said student station and/or said teacher station. In yet another aspect, one or more of said student stations are located in a physical location that is remote to one or more of said teacher stations. In another aspect said student interaction interface module is comprised of a writing interface module unit comprised of a digital desk pad sampling and communication circuits capable of electrically interfacing to one or more of the following: a digital desk pad capable of capturing/generating signals that replicate a student's graphical interaction with said pad and transmitting/communicating the signals to said student station and/or said teacher station. In yet another aspect, one or more of said student stations are located in a physical location that is remote to one or more of said teacher stations.

Other features and advantages of the present invention will become apparent upon examining the following detailed description of an embodiment thereof, taken in conjunction with the attached drawings.

### BRIEF DESCRIPTION OF THE DRAWINGS

FIG. 1 is a system layout for the proposed solution, according to an exemplary embodiment of the invention.

FIG. 2 is a system layout, with emphasis on the custom-built components, according to an exemplary embodiment of the invention.

FIG. 3 shows details of the science interface module unit, according to an exemplary embodiment of the invention.

FIG. 4 shows details of some science interface module components and sensors, according to an exemplary embodiment of the invention.

FIG. 5 illustrates a remote professor system solution, according to an exemplary embodiment of the invention.

FIG. 6 illustrates a remote professor, multi classroom solution, according to an exemplary embodiment of the invention.

The above-described and other features will be appreciated and understood by those skilled in the art from the following detailed description, drawings, and appended claims.

### DETAILED DESCRIPTION OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

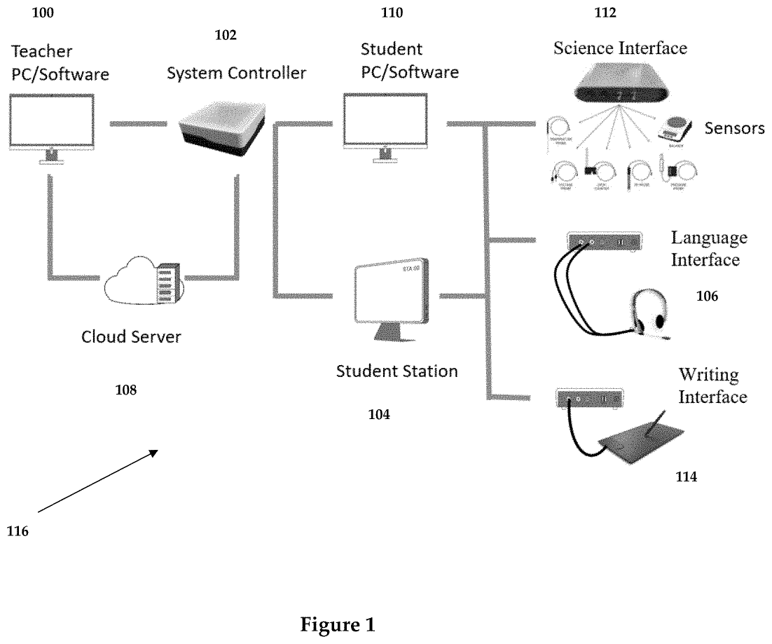

In one embodiment, the proposed solution 116 (FIG. 1) is comprised of one or more Teacher stations 100. Each said teacher station/system controller, student station and interaction modules are comprised of memory and a processor capable of electronic networking with the other system components. In addition, the Teacher and student interaction components have screens, touch screens, keyboards, and/or a personal computer (PC)) for interacting with humans. The Teacher station, in addition, has within the supervisory/control software to control one or more system controllers 102, cloud servers 108/504, and interact with students stations 104/110.

The student stations may be any combination of Personal computing device (e.g. PC, Table, Smartphone, Terminal, etc.) working as either as a standalone device 110 or as an App within such a device or student stations 104. These are the primary student interface units, and they may be comprised of an embedded PC computer system similar in operation to a tablet PC. In short, the student stations are capable of running on any person's PC or it may be hosted in any suitable unit like a tablet/smartphone 104.

The student stations are interfaced to one or more student interaction interface modules, which may include a science interface module unit 112, a language interface module unit 106, a writing interface module unit 114 and/or others. The interface modules 106/112/114 are the primary tool for collecting data from real world experiments (through sensors), audio/handwriting samples (for language/writing interface tests), scientific instruments (such as a spectrometer or other lab. tool result), identifying where data comes from and ‘pairing’/provenance of the data to a student station representing a student and/or a group of students as part of a scientific experiment or a test.

The various units may be linked via wired/wireless Local Area Networks (LAN) or Wide Area Networks (WAN), including 3G/4G/5G networks, Wi-Fi, Ethernet and other similar connectivity protocols. In operation, on bootup, the System Controller 102 starts all the necessary software components and verifies its major functions are running as expected.
i) Wireless Access Point for Stations 110 and 104: It starts a wireless access point for stations to connect to. The device does not broadcast its SSID, to connect to it, the Student Stations must have the devices ID and be within range of the Wi-Fi network
ii) Connection with Teacher PC/Software 100: When the controller successfully joins a LAN, user(s) running the Teacher Software (on the same local network) should be able to see and connect to the controller.
iii) Cloud Server 108 connection: This is the security triple point security check for remote applications.

The whole system is capable of deploying real time educational material from the Teacher Computer 100 to the students Stations 110 and 104. The Teacher Computer 100 monitors in real time the data produced by the students in the execution of laboratories, experiments, exercises, quizzes and exams. The data produced is synchronized with the Teacher Computer 100 in real time even is the teacher is connected remotely from a different location.

The System Controller 102 is a small embedded PC that acts both as an information gateway between the Teacher Software 100 and the Student Stations or PC 104/110, and as a wireless access point for the stations. Some of the proposed key features include being a small, unobtrusive device to bridge Student Stations to PCs and other devices. Acting as a wireless access point for the Student Stations or PC 104/110. Connecting to a local area network via ethernet port or Wi-Fi.

The controller 102 provides authentication, data routing and management for the Student Stations. Interfacing with devices running the Administrator Software via LAN or USB connection. Software upgradeability via pushed updates or local flashing.

The minimum general hardware includes an embedded PC or Small Form-factor PC with at least one (1) USB port and one (1) Ethernet port. One or more antenna for wireless communication (e.g. Wi-Fi or Bluetooth). OLED screen or LED arrays for boot monitoring and error codes, internal power supply and regulator, enclosure made of chemically plastic (e.g. PVC, PEEK or PVDF), anodized metal or resistant power coat metal.

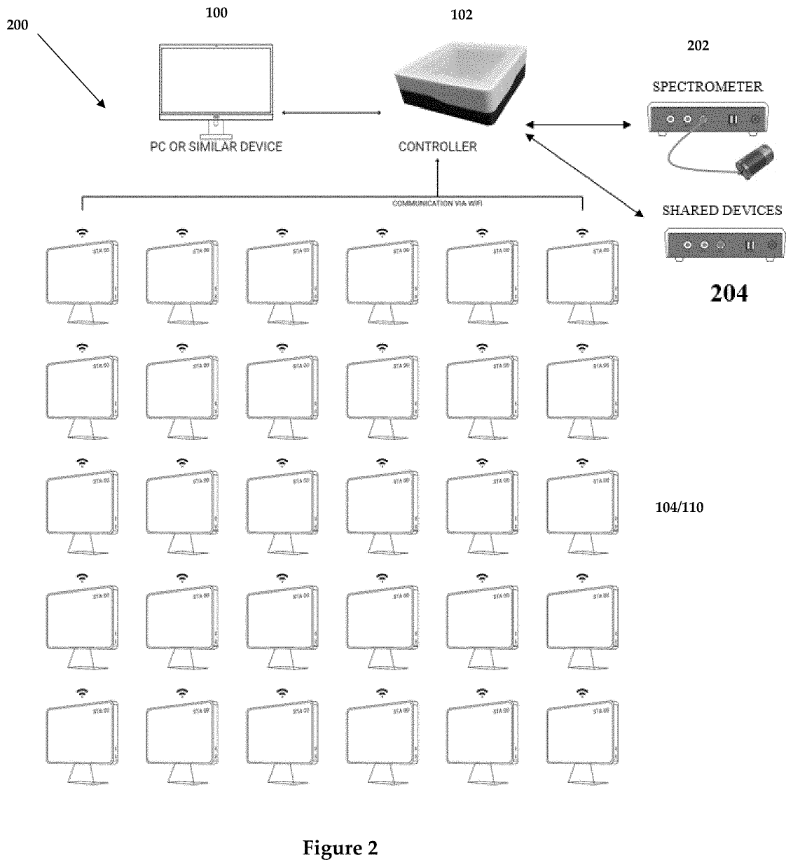

Referring to FIG. 2, we get a better appreciation for the layout within which the software in this network 200 unit operates. Through the combination of several custom built, repurposed and readily-available pieces of software, the System Controller 102 performs the following functions in tandem: Wireless Access Point for Student Stations or PC 104/110, Station Communications and Data Routing, Connection with the Teacher PC Software 100 and connection with students Shared Devices 204 like an Spectrometer 202.

When any station joins the network controller, user authentication take place; the details of which can be adjusted by within the Teacher Software 100. Once a Student Station or PC 104/110 joins a network, it is added to the paired stations list. The controller software categorizes all stations in this group into three general categories:
i) Offline: The station is currently powered off or has lost connectivity.
ii) Idle: The station is powered on and online, but is currently not running any module.
iii) Active: the station is currently running a module.

The exchange of data and instructions is constant. The controller (according to its configuration) decides how to react and what to do with any received data.

Shared Devices 204: The System Controller 102 allows the connection of shared devices. These devices are expensive devices that the students will share the usage in the class. One example of this devices is a Spectrometer 202. The System Controller 102 will allow the use of this devices for all the students in an orderly manner.

The System Controller 102 would allow the connection of the registered Student Stations or PC 104/110 and the authorized Techer Computer 100. This provide a layer of security for the students. Also, will avoid signal mix-ups from adjacent classrooms and also from the institutions internal network. If there is any requirement to share a device, the System controller 102 would allow the Teacher computer 100 to arbitrate/schedule. In a similar fashion, the system controller 102 may block the access to the internet of the Students Station or PC 104/110.

The System Controller technology allow the communications of the network to be fast and reliable. All the data is stored in the System Controller 102 memory. The data is synchronized in the background as soon as the Techer PC 100 or the Student Station or PC 104/110 is connected to the network. Then the software just deploys the data avoiding the streaming delays.

The Teacher Software 100 serves the purpose of managing and controlling a Classroom Network and the Class Content in conjunction with the System Controller 102. In essence, it acts as control panel and terminal for the System Controller 102. Connects to a System Controller 102 located on the same local network or through the Cloud Server 108 if the connection is from a remote location.

The Configured Classroom Network settings may reside in the System Controller 102 (e.g. users and user authentication level). In this fashion, the controller 102 may monitor Student Station 104 or PC 110 activity in real time. In this fashion, it may receive, open and graph experiment data, quizzes and exams results received from Student Stations 104 or PC 110. Can send data and instructions to the Student Station via the System Controller 102.

In one embodiment, the standard configuration for any given classroom. This allows for one (1) or more device running the Teacher Software to manage and live-monitor a network of one (1) or more Student Stations 104 or PC 110 managed by a single network controller. At its most basic, it consists of one (1) System Controller 102, one (1) Teacher PC 100 running the Teacher Software and one (1) or more Student Stations 104 or PC 110. The Teacher Software operation 100 allows the system to save the class material as a unit for future us and export the class material to be use in another system.

Creation of quizzes and exams with the definition of the correct answer is a feature of the teacher software running in the teacher PC 100. This software evaluates the students answer in real time and the teacher sees the evaluation and statistics immediately. In the quiz the teacher sends the question during the course and the students answer the question in the moment all the students at the same time. In the exam the questions are sent, and the students answer the question on their own pace.

The Teacher Software 100 provides the tools to manage the network and control the class content, including but not limited to:
i) Monitoring the activities of connected networks stations.
ii) Remotely control the Student Stations to perform actions like powering off.
iii) Receive and graph live data from the network stations.
iv) Receive data files from the network stations.
v) Adjust the controller's connectivity, data and security settings.
vi) Receive the quizzes and exam answer of the students.
vii) Prepare the class content in text, images and video.
viii) Enforce material focus.

As for the Student Station 104, in one embodiment, it is an embedded PC, equipped with a single touchscreen display, wireless networking and at least one communication port for expansions and peripherals. Acting as the student's terminal to the network, it allows the student to run educational modules and connect compatible devices to further expand the capabilities of the device. One such device is the science interface module unit 112, allowing the station to run and capture real data within a number of science experiments.

Some of the Student Station 104 key features include simple construction consisting of a capacitive touch screen display and an embedded pc within a simple slab enclosure, similar to a modern tablet computer. Optionally mounted in an “L” shaped swiveling base. Connects to the Classroom Network via the System Controller 102 integrated Wi-Fi network. Can run a number of educational and utility modules/apps. Limited functionality and access of the device when used outside of the network outside of the network. Features and functionality available to students can be controlled by the Classroom Network it is currently connected to. Seamless integration with different interfaces. Software upgradeability via remotely pushed updates or local firmware “flashing”.

In one embodiment, the proposed minimum general hardware includes; Touch-enabled, capacitive IPS LCD panel with its corresponding LCD controller. Small form-factor embedded PC with its most common components. Internal or external (power brick) power supply and regulator, enclosure made of resistant plastic (e.g. PVC, PEEK or PVDF), anodized metal or power coat metal.

The Student Station 104 runs custom built software on top of a lightly modified distribution of the Linux operating system. The custom software acts as pseudo-desktop environment to launch all other modules/apps. This approach heavily restricts the access to the core OS and other software by the end user, limiting them only to modules and classroom approved content.

In another embodiment, there is a standalone PC Software 110 native application running on any target Operating System (e.g. Windows, Mac OS and Android). Such a ‘soft’ implementation would use the student's choice of hardware platform while sharing the software functionality of the student station 104 in connecting to the other parts of the system.

Some of the standalone PC software 110 key features include the ability to: Serve as a platform to host and launch modules, in the same manner as the Student Station 104. Runs on the Windows 7 (and up) operating system. Connect to the different student interaction interface modules, including the science interface module 112, the language interface module 106 or the writing interface module 114 via a USB port on the host machine. Intended to serve as a Student Station 104 alternative for remote students, ap students and homeschooled students.

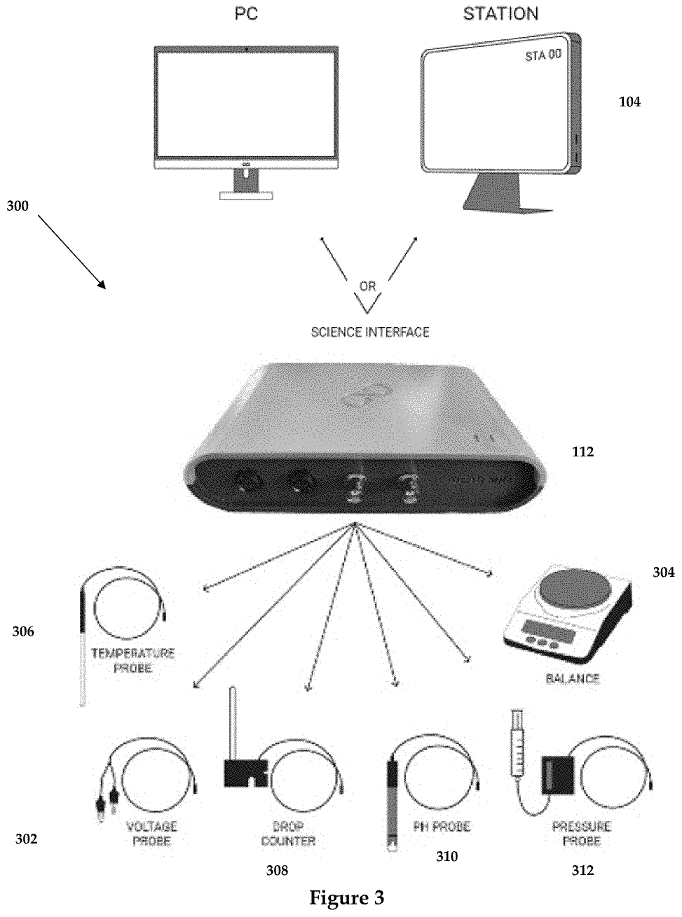

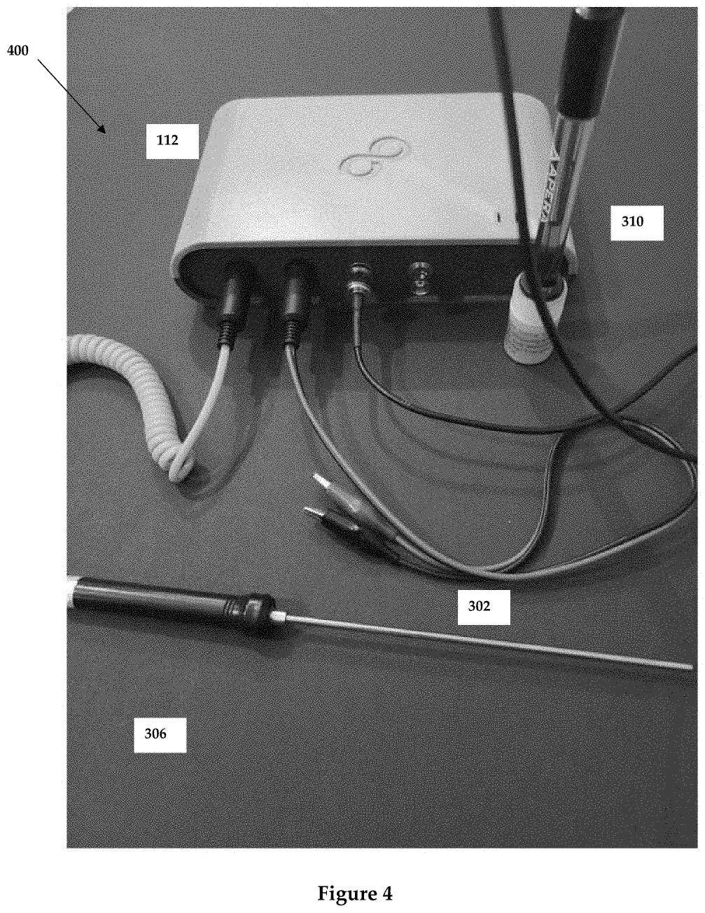

Referring to FIGS. 3 and 4 we see an embodiments of the proposed invention. The science interface module 112 is connected to various sensors (temperature probes, drop counters, etc.), and connected to a Student Station or PC 104/110. Each Student Station would be then connected to a System Controller 102, which interfaced to a computer system intended to be used by the instructor/teacher.

The science interface module unit 112 is a component designed 300 to electrically interface so as to be able to read different type of sensors independently and/or simultaneously with only one electronics. Example of this is the interface is capable to read pH 310, voltage 302, temperature 306, pressure 312, resistance, conductivity, time and more sensors 302/306/308/310/312 with the same electronics.

In this fashion, a student equipped with an SI unit 112 is capable of performing a number of experiments, while all the measurements are monitored in real-time by the teacher. One or more of these science interface module 112 could be networked to more expensive experimental units (e.g. a Diode-Array Spectrometer), while preserving the connection to the network controller and instructor unit.

When discussing the hardware components (FIG. 4) of particular note 400 is the science interface module 112 which in one embodiment is a small peripheral that acts as a bridge between a number of different analytical sensors 302/306/308/310/312 and instruments 304, and the Student Station or PC 104/110. It takes analog signals and converts them to a digital signal that can be passed along to a connected computer (or device) that can further use and interpret the data.

The Student Station or PC 104/110 now is the control panel of the laboratory instrument. The software still be the same software, the student does not need to learn another software. The teacher will monitor in real time the data acquisition of every student using the Teacher PC 100 with the same control software.

Some of its key features include the ability to work with a broad range of instruments and sensors 302/306/308/310/312 and 304, working with any PC running companion software via a network connection (be it a wired (e.g. USB, Ethernet or similar) connection or a wireless connection (e.g. Bluetooth, Wi-Fi or similar) depending on speed/topology limitations), working with the Student Station via a network connection, at least three analog inputs to read signals from connected sensors and instruments 302/306/308/310/312 and 304, at least one digital input to connect more complex instruments and expansions with the proprietary communication protocol and at least one RS-232 serial port to connect to instruments from different manufacturers. The design allows to read simultaneous from all the ports for experiments that require the acquisition of more than one variable, as example pH and temperature in order to correct the pH reading that is temperature dependent FIG. 4.

A proposed minimum general hardware would include at least 2 analog instrument/sensor inputs (e.g. Mini-DIN-9), at least one (1) digital input for digital instruments and peripherals (e.g. Mini-DIN-6), at least one (1) BNC connector for electrodes, at least one RS-232 serial connector for instruments, one digital port for data connectivity with Student Station or PC 104/110 (e.g. USB), one or more antenna for wireless communication (e.g. Wi-Fi or Bluetooth), OLED screen or LED arrays for boot monitoring and error codes, internal power supply and regulator, enclosure made of chemically resistant plastic (e.g. PVC, PEEK or PVDF), anodized metal or chemical resistant power coat metal.

Some of the general functionality of the SI unit 112 includes; analog Inputs-Standard sensor and instrument connection. It is a multi-pin connection; depending on the type of sensor, 2 or more of the pins might be active. Different pins may be used for different purposes, providing power, receiving signals, etc. Digital Input—Digital inputs are read and verified by the microcontroller/microprocessor.

Reading signals includes the ability of the interface to carry out the following measurement functions: voltage, with a range of −2.5 v to +2.5 v; current, with a range of 4-20 mA; resistance in Ohms. In short, the unit behaves like a digital multimeter. Every type of measurement function requires and follows its own path in the circuitry. The signals generated by these different circuits are read by the boards' ADC chip. The digital values generated by the ADC chip are then read by a microcontroller/microprocessor. The microcontroller/microprocessor digitally filters noise and can perform additional data modeling or interpretation if required. It then packages and prepares the data to be provided to the Science Module over the network.

In one embodiment, the science interface module unit 112 relies on USB communication to communicate to a device running the Science Module. This USB communication is handled by an independent IC. The IC acts as a bridge between the microcontroller/microprocessors SPI or UART communications and USB. The electronics of the science interface module 112 and the software allows the calibration of each sensor.

The science interface module 112 is the primary module to be included with both the Student Station or PC 104/110 and the Science Standalone Software. It is designed to work with the science interface module exclusively and directly, allowing users to perform a number of different experiments and analysis with the data it provides. Some of its key features include the ability to: Read data from a connected science interface module 112. Offer a number of different interactive experiments and data analysis. Interprets and visualizes this data via a number of different charts and graphs.

Among its capabilities it can perform a number of experiments and analysis with the scientific data provided by the science interface module 112. Save experiment data in the Student Station or PC 104/110 and sends a copy of the original data to the Teacher PC 100. Can stream experiment data to a connected System Controller 102 live, or send the complete data once an experiment is over. Available in both the Student Station or PC 104/110 and Standalone software.

In one proposed embodiment, when an experiment or analysis option is selected, it verifies with the science interface module that the necessary sensors/instruments are connected and available. It alerts the user if anything is out of order. Once the experiment is started the data is received and it is interpreted to fit the experiment's parameters. If the experiment or analysis relies on any form of graph, chart or other visual representation of the data, it is displayed and updated in real time.

As an experiment or analysis starts and progresses, the data is streamed in real time or stored in a buffer until the student station or computer is connected System Controller 102. Once an experiment or analysis is complete, the data may be saved locally in a file on the Student Station or PC or 104/110 in the Standalone Software. The file containing the complete experiment data can be reloaded to be viewed and re-graphed at any moment.

The language interface module 106 is designed for language laboratories using the same software and system as the other interface modules. The interface module 106 is connected to the Student Station or PC 104/110 via USB or wireless communication. The student wears a headset to perform the pronunciation exercises. This interface allows the teacher electronic audio connection so they may hear/speak/communicate (Text/Instant Messaging) to every student in the connected to network individually. The language interface module 106 records the pronunciation and sends the recording to the Teacher PC 100 through the System Controller 102 for the evaluation of each student individually.

A proposed minimum hardware would include at least one (1) phone jack to connect the headset for headphones and microphone, one digital port for data connectivity with Student Station or PC 104/110 (e.g. USB one or more antenna for wireless communication (e.g. Wi-Fi or Bluetooth), OLED screen or LED arrays for boot monitoring and error codes, internal power supply and regulator, enclosure made of resistant plastic (e.g. PVC, PEEK or PVDF), anodized metal or power coat metal.

The writing interface module 114 is designed to perform writing exercises using the same software and system. The interface is connected to the Student Station or PC 110, 104 via USB or wireless communication. The student will use a digital desk pad to write connected to the writing interface module 114. In one embodiment, the desk pad will display the notebook lines and dotted letters to follow the path. The teacher operating the Teacher PC 100 can watch the writing of the students in real time to evaluate the correct construction of letters.

The writing interface module 114 records the student writing and sends the recording to the Teacher PC 100 through the System Controller 102 for the evaluation of each student individually. This will help in correction of the writing but also to identify conditions and possible impairments that are related with improper construction of letters.

A proposed minimum hardware would include at least, one digital port to connect the touchscreen desk pad and electronic pen, one digital port for data connectivity with Student Station or PC 110, 104 (e.g. USB one or more antenna for wireless communication (e.g. Wi-Fi or Bluetooth), OLED screen or LED arrays for boot monitoring and error codes, internal power supply and regulator, enclosure made of resistant plastic (e.g. PVC, PEEK or PVDF), anodized metal or power coat metal.

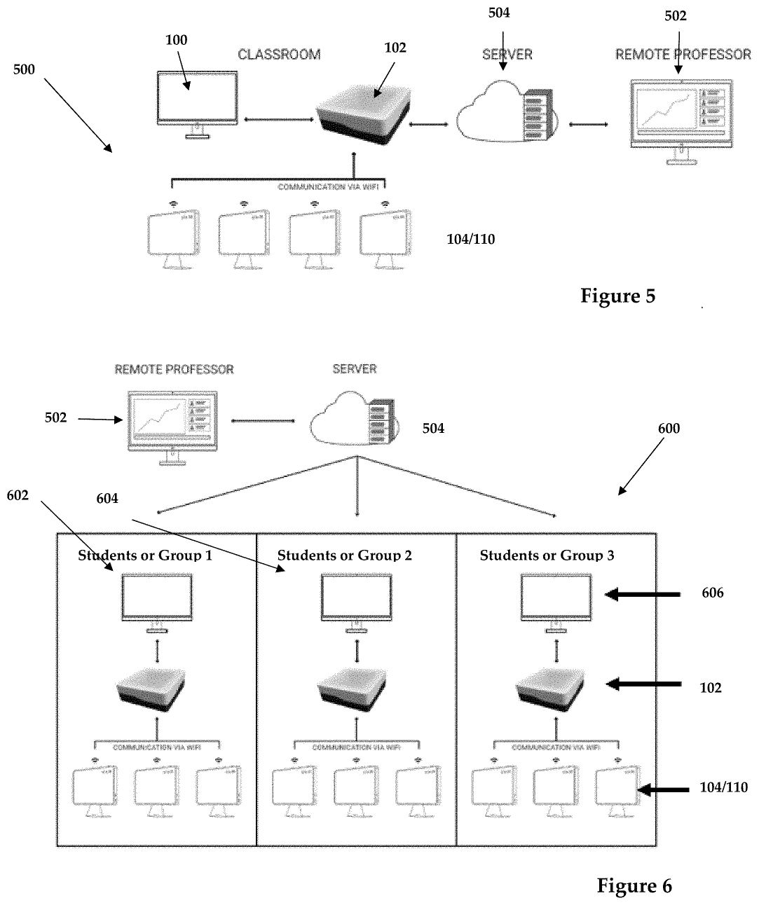

In one embodiment 500, the professor/instructor/teacher (collective called the supervisor) (FIG. 5) monitors one or more of the Student Stations or PC 504 via a laptop or other such computer 502 networked to the units (as before, such networking may be wired or wireless, as suitable). A significant advantage of this proposed embodiment, is that the supervisor and/or the students may be located remotely and connected via video conference and interface units. In this fashion, the instruction continues to be personal and one-on-one without requiring the in-person presence of a highly skilled instructor. The immediacy of the Science and Language/Writing interface units augments a simple video-conference, for it would allow one or more of the remote groups to perform an experiment, while the instructor (in yet another location) is able to monitor the physical things being measure (say temperature, pH, etc.).

In the above fashion, an instructor may teach eight one-hour classes in any continent, with the in-person presence handled by someone with less specific expertise, all without sacrificing discipline. In one embodiment 600, the instructor may be simultaneously teaching one 602, two 604, three 606 or more students and/or student groups (FIG. 6), where there may be a combination of presence/remote locations routed through one or more system controllers/cloud servers.

The overall system will count with one or more authentication/connection Cloud Servers (ACS) 504 in the cloud, which will authorize and police any remote connection from a user using the Teacher PC Software 502 to a System Controller 502. This ACS keeps a list of all registered Classroom Networks and associated data (such as a list of users). Keeping such a registration of a Classroom Network to the server is optional but necessary for Remote Classroom Connections, so that a token authentication system that may be used to authenticate temporary remote connections into Classroom Networks. These tokens are a short alphanumeric value that can be generated by the classroom network controller via the administrator software connected locally to it. This manages the data routing and logistics for Remote Classroom and Multiple remote classrooms connections.

The security protocol will include a triple point check and includes hardware ID, software license and passwords. The Cloud Server 504 authenticate the Remote Computer 502 and its licensed software and match the access to the corresponding System Controller 502. The System Controller 502 will require the access pin that was randomly generated by the Local Computer 502 to grant the access to the classroom. All the computer software will require a password to be accessed.

The system is capable of connecting:
i) One teacher with one classroom
ii) One teacher with multiple classrooms
iii) One teacher with one student
iv) One teacher with multiple students in different locations (e.g. homeschooling)

The system is designed to work with a parallel video conference system or with an embedded video conference as well.

### Example

When a network station begins running an experiment via the Science Module, it sends a message to the controller containing the metadata of the experiment. As the experiment progresses, messages containing the data from the experiment may be received in real time. The System Controller 102 decides, according to its settings, to save the data locally and/or stream it in real time to any connected device running the Teacher Software 100.

The Remote Classroom Network & Multiple Remote Classroom Network allows a remote user running the Teacher Software 502 to connect to one or more Classroom Networks. Connections are made through the Authentication/Connection Cloud Servers 504. Although the Teacher Software 502 operates as it would normally in a local Single Network Configuration, there will be added latency that depends on many factors such as the quality of the internet connection at all ends.

To remotely connect to a System Controller 502, the connecting software makes a request to the Cloud Server 504. If available, the server references a list of authorized user accounts associated with the target Classroom System Controller 502. If the user account attempting to connect is not authorized, or the target Classroom Network otherwise requires it, the server then requests an authentication token from the requesting user. Once the token is provided, the server verifies the authenticity of the token, and any time or feature restrictions associated with the token. Once approved, the server then opens a direct connection between the remote user and the target Classroom System Controller 502. The server then proceeds to route and repackage data received from the Classroom Networks(s) to deliver it more efficiently to the remote Teacher Software 502. The server closely monitors the exchange of data for anomalies and data.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A system for interactive student education, said system comprising:
one or more teacher stations;
one or more student stations;
a system controller;
one or more student interaction interface modules, each said interface module capable of interacting with one or more sensors;
wherein said one or more controller(s), said teacher station(s), said student station(s) and said interaction interface modules are electronically networked.

2. The system of claim 1 wherein:
said student interaction interface module is comprised of a science interface module unit comprised of both analog and digital electronic sampling and communication circuits capable of electrically interfacing to one or more, individually or simultaneously of the following:
pH probe, voltage measurement, current measurement, temperature gage probe, pressure gage probe, electrical resistance measurement or electrical conductivity measurement while tracking the measurements over time and communicating them to said student station and/or said teacher station.

3. The system of claim 2 wherein:
one or more of said student stations are located in a physical location that is remote to one or more of said teacher stations.

4. The system of claim 1 wherein:
said student interaction interface module is comprised of a language interface module unit comprised of both analog and digital electronic sampling and communication circuits capable of electrically interfacing to one or more of the following:
a headset, earpiece, microphone or similar audio communication component capable of capturing/generating sounds (in either analog or digital form) and transmitting/communicating the signals to said student station and/or said teacher station.

5. The system of claim 4 wherein:
one or more of said student stations are located in a physical location that is remote to one or more of said teacher stations.

6. The system of claim 1 wherein:
said student interaction interface module is comprised of a writing interface module unit comprised of a digital desk pad sampling and communication circuits capable of electrically interfacing to one or more of the following:
a digital desk pad capable of capturing/generating signals that replicate a student's graphical interaction with said pad and transmitting/communicating the signals to said student station and/or said teacher station.

7. The system of claim 6 wherein:
one or more of said student stations are located in a physical location that is remote to one or more of said teacher stations.

8. A computer-implemented method for interactive student education, performed by one or more processors, said method comprising:
providing one or more teacher stations;
providing one or more student stations;
providing a system controller;
providing one or more student interaction interface modules, each said interface module capable of interacting with one or more sensors;
wherein said one or more controller(s), said teacher station(s), said student station(s) and said interaction interface modules are electronically networked.

9. The method of claim 8 wherein:
said student interaction interface module is comprised of a science interface module unit comprised of both analog and digital electronic sampling and communication circuits capable of electrically interfacing to one or more of the following, individually or simultaneously:
pH probe, voltage measurement, current measurement, temperature gage probe, pressure gage probe, electrical resistance measurement or electrical conductivity measurement while tracking the measurements over time and communicating them to said student station and/or said teacher station.

10. The method of claim 9 wherein:
one or more of said student stations are located in a physical location that is remote to one or more of said teacher stations.

11. The method of claim 8 wherein:
said student interaction interface module is comprised of a language interface module unit comprised of both analog and digital electronic sampling and communication circuits capable of electrically interfacing to one or more of the following:
a headset, earpiece, microphone or similar audio communication component capable of capturing/generating sounds (in either analog or digital form) and transmitting/communicating the signals to said student station and/or said teacher station.

12. The method of claim 11 wherein:
one or more of said student stations are located in a physical location that is remote to one or more of said teacher stations.

13. The method of claim 8 wherein:
said student interaction interface module is comprised of a writing interface module unit comprised of a digital desk pad sampling and communication circuits capable of electrically interfacing to one or more of the following:
a digital desk pad capable of capturing/generating signals that replicate a student's graphical interaction with said pad and transmitting/communicating the signals to said student station and/or said teacher station.

14. The method of claim 13 wherein:
one or more of said student stations are located in a physical location that is remote to one or more of said teacher stations.

15. A non-transitory computer-readable medium storing computer-readable instructions executable by a computer including one or more processors, and the computer-readable instructions configured, when executed by the one or more processors to:
providing one or more teacher stations;
providing one or more student stations;
providing a system controller;
providing one or more student interaction interface modules, each said interface module capable of interacting with one or more sensors;
wherein said one or more controller(s), said teacher station(s), said student station(s) and said interaction interface modules are electronically networked.

16. The non-transitory computer-readable medium of claim 15 wherein:
said student interaction interface module is comprised of a science interface module unit comprised of both analog and digital electronic sampling and communication circuits capable of electrically interfacing to one or more of the following, individually or simultaneously:
pH probe, voltage measurement, current measurement, temperature gage probe, pressure gage probe, electrical resistance measurement or electrical conductivity measurement while tracking the measurements over time and communicating them to said student station and/or said teacher station.

17. The non-transitory computer-readable medium of claim 16 wherein:
one or more of said student stations are located in a physical location that is remote to one or more of said teacher stations.

18. The non-transitory computer-readable medium of claim 15 wherein:
said student interaction interface module is comprised of a language interface module unit comprised of both analog and digital electronic sampling and communication circuits capable of electrically interfacing to one or more of the following:
a headset, earpiece, microphone or similar audio communication component capable of capturing/generating sounds (in either analog or digital form) and transmitting/communicating the signals to said student station and/or said teacher station.

19. The non-transitory computer-readable medium of claim 18 wherein:
one or more of said student stations are located in a physical location that is remote to one or more of said teacher stations.

20. The method of claim 15 wherein:
said student interaction interface module is comprised of a writing interface module unit comprised of a digital desk pad sampling and communication circuits capable of electrically interfacing to one or more of the following:
a digital desk pad capable of capturing/generating signals that replicate a student's graphical interaction with said pad and transmitting/communicating the signals to said student station and/or said teacher station; and
one or more of said student stations are located in a physical location that is remote to one or more of said teacher stations.
